(19) United States
(12) Patent Application Publication
(10) Pub. No.: US 2010/0314946 A1
(43) Pub. Date: Dec. 16, 2010

(54) FLOOR COVERING AND INDUCTIVE POWER SYSTEM

(75) Inventors: Wolfgang Otto Budde, Aachen (DE); Pieter Jacob Snijder, Eindhoven (NL); Lucas Leo Disiree Van Der Poel, Eindhoven (NL); Victor Adrianus Joseph Teeven, Eindhoven (NL); Eberhard Waffenschmidt, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Einghoven (NL)

(21) Appl. No.: 12/446,473

(22) PCT Filed: Oct. 23, 2007
(86) PCT No.: PCT/IB07/54301

§ 371 Date: Apr. 21, 2009

(30) Foreign Application Priority Data
Oct. 26, 2006 (EP) 06123010.8

(51) Int. Cl. H02J 17/00; E04B 5/43; H02J 7/00

(52) U.S. Cl. 307/104; 52/173.1; 320/108

(57) ABSTRACT

The invention relates to a floor covering (100) comprising: a plurality of coils (110), each coil (110) being operable to supply inductive energy to a power receiver circuit (200); wherein the plurality of coils comprises a transmitter area occupying the largest area of the floor covering (100); and a charging current through the coils is operable to generate said inductive energy.

### FIELD OF THE INVENTION

The present invention relates to inductive power systems and a floor covering, and more particularly to a floor covering comprising one or more coils of the inductive power system which is operable to supply inductive energy to a power receiver circuit.

### BACKGROUND OF THE INVENTION

A large percentage of present-day electronics operates wirelessly, and this trend is expected to increase in the future. Portable appliances such as cell-phones, PDA, remote controls, notebooks, lamps, etc. represent only the beginning of what is expected to be a growing number of wireless devices in various industrial sectors.

Portable and wireless appliances typically require power for operation, usually coming in the form of portable power storage by rechargeable or replaceable batteries. Rechargeable batteries are particularly advantageous, as they avoid the necessity of frequent replacement. Rechargeable batteries are often recharged by using induction means, wherein an inductive power pad is used to supply inductive energy to a power receiver circuit located within the portable appliance. The inductive power pad itself is usually supplied with energy via connected wires and plugs.

The use of inductive power pads is not without drawbacks. In particular, conventional inductive power pads emit strong inductive fields which can interfere and produce harmful interactions with other electric and biological systems in close proximity. These fields can produce eddy currents in unprotected electronics and consequently damage or destroy them, and they can interfere with biological systems and implants.

### OBJECT AND SUMMARY OF THE INVENTION

It may be desirable to provide an improved inductive power system that supplies inductive energy everywhere within a room (e.g. office room), but locally where it is needed.

This need can be met by a floor covering and an inductive power system as defined in the independent claims.

In one embodiment of the invention, a floor covering comprises a plurality of coils. If the floor covering is used only for a small area, a single coil may be sufficient. If the floor covering covers a large area of a room, a plurality of coils is preferred. Each coil is operable to supply inductive energy to a power receiver circuit. The plurality of coils comprises a transmitter area occupying the largest area of the floor covering. The charging current through the coils is operable to generate said inductive energy inside the transmitter area.

In another embodiment of the invention, an inductive power system is presented. The inductive power system includes a power receiver circuit which is operable to receive inductive power, and a floor covering, as described above and hereinafter.

In a preferred embodiment of the invention, the plurality of coils is embedded in the floor covering, so that the transmitter area of the plurality of coils occupies the largest area of the floor covering. The inductive energy is therefore supplied throughout the transmitter area. The power receiver circuit is operable to receive inductive energy independently of its position on the floor covering. The floor covering further includes a wiring system selectively supplying a charging current from a power supply to each coil of the plurality of coils. The arrangement of coils is preferably as dense as the transmitter area of these coils occupying the largest part of the whole area of the floor covering.

Examples of features and refinements of the floor covering according to the invention will now be described. However, these features and refinements also apply to the inductive power system.

In one embodiment, the floor covering further comprises an upper protection layer. In a further embodiment, the floor covering further comprises a wiring system. The wiring system is operable to supply a charging current from a power supply to the plurality of coils.

In another embodiment, the plurality of coils and the wiring system are integrated in a flexible substrate. This flexible substrate is attached to the protection layer. This allows integration of the plurality of coils in the substrate of the floor covering already during production of the floor covering itself. In a further refinement of this embodiment, the wiring system and the plurality of coils are insulated by an insulating layer. In a further refinement of this embodiment, the wiring system and the plurality of coils are structured by means of photolithography.

In one embodiment, wires of said wiring system and/or said plurality of coils are woven and/or embroidered and/or sewn into the upper protection layer. This can preferably be done already during a production process of the upper protection layer itself or afterwards in a subsequent process step, using sewing machines, etc. In a further refinement of this embodiment, the wiring system and the plurality of coils comprise cables with a surrounding insulation. In a further refinement of this embodiment, the insulation is lacquer.

In further refinements, the wiring system and the plurality of coils are connected by soldering and/or spot-welding and/or non-insulating gluing and/or a connector assembly.

In a further embodiment, said coils are positioned adjacent to each other. Consequently, the space between two coils is significantly smaller than the diameter of the coils. In a refinement of this embodiment, the coils are arranged in a matrix configuration. To position the coils adjacent to each other, it is advantageous that the coils overlap partly and that the overlapping coils are arranged in different layers.

In another embodiment, the floor covering further comprises a plurality of switches. Each switch corresponds to at least one coil of said plurality of coils. Each switch is operable to switch the charging current to the at least one connected coil. In a further refinement of this embodiment, the wiring system further comprises at least one power rail connected to each switch and to the power supply.

In a further embodiment, each coil comprises wire windings or foils. In a refinement of this embodiment, these wire windings or foils are fixed in a certain position within the substrate. Each coil has a spiral or rectangular shape. The wire windings or foils are planar and positioned in-plane of the floor covering, so that the magnetic flux density within the coils is preferably directed perpendicularly to the main plane of the floor covering.

In one embodiment, the floor covering further comprises a magnetic material which is capable of improving the magnetic coupling between the coils and the power receiver circuit. Such a magnetic material may be soft-magnetic wires, a ferrite polymer compound or a mumetal foil.

A further embodiment of the floor covering comprises a visual indicator. This indicator is printed on the rear side of the floor covering. In a first refinement of this embodiment, the indicator indicates areas for cutting the floor covering. The indicator indicates where to cut the material best without cutting wires of the coils or wiring system. In a second refinement of this embodiment, the indicator indicates a predetermined point of fracture. Breaking at this predetermined point of fracture disconnects parts of the coils. In this case, the indicator indicates parts of coils that have to be cut when tailoring the floor covering to the exact room dimensions. This will prevent short-circuiting.

Another embodiment of the floor covering comprises a respective plurality of detector circuits, each detector circuit corresponding to one of the plurality of coils and each detector circuit being operable to electromagnetically sense a power receiver circuit. For example, the detector circuit is or comprises a sensor winding. In a refinement of this embodiment, the sensor winding is embedded in the floor covering so as to detect any electric or electronic device placed on it. In a further refinement of this embodiment, each detector circuit is operable to electromagnetically sense a power receiver circuit. Upon electromagnetically sensing a power receiver circuit, each detector circuit enables or is operable to control switching of its corresponding coil to a power supply, thereby supplying a charging current to its corresponding coil. The charging current is operable to generate inductive energy for transmission to the power receiver circuit.

Each detector circuit is operable to couple its coil to the power supply when the detector circuit detects a magnetic field emanating from the power receiver circuit. In a further refinement of the invention, each detector circuit includes a detector inductor having a first inductance L₁ in the absence of the magnetic field emanating from the power receiver circuit, which condition is operable to decouple the corresponding coil for the power supply, and a second inductance L₂ in the presence of the magnetic field emanating from the power receiver circuit, which condition is operable to couple the corresponding coil for the power supply. In a further aspect of this embodiment, a resonant capacitor is coupled in parallel with the detector inductor, wherein the inductance of the detector inductor and the capacitance of the resonant capacitor are operable to collectively provide a resonant operating frequency for the detector circuit. Optionally, each detector circuit is operable to receive a reference voltage, and each detector circuit additionally includes a switch which is operable to couple between the transmitting inductor and the power supply, and a differential amplifier which has a first input coupled to the detector inductor and the resonant capacitor, a second input coupled to receive the reference voltage, and an output for controlling the switching state of the switch.

An embodiment of the inductive power system further comprises a remote control device with a transmitter which is operable to remotely control an electronic device wirelessly. In this embodiment, the remote control device comprises said power receiver circuit. In a refinement of this embodiment, the remote control device comprises a switch and/or a push-button and/or a slider.

A further embodiment of the inductive power system comprises a transmitting circuit connected to the plurality of coils, which circuit is operable to transmit data to the power receiver circuit. In a refinement of this embodiment, the data is transmitted by modulating the charging current. Alternatively, an extra coil for data transmission can be used. In a further refinement of this embodiment, the power receiver circuit comprises means for receiving the transmitted data. In another refinement of this embodiment, the transmitting circuit is operable to transmit and receive data bidirectionally. In a further refinement of this embodiment, the inductive power signal and the transmitted and/or received data are separated by a plurality of frequency-selective filters.

In a further refinement of the invention, the wiring is connected to each coil so as to supply the charging current to each coil selectively. The charging current is switched only to a coil of the plurality of coils with one or more power receiver circuits. In a further refinement of the invention, the charging current of two, e.g. adjacent, coils differs in phase or frequency so as to reduce unwanted steady-state superposition.

These and other aspects of the present invention are apparent from and will be elucidated with reference to the embodiments described hereinafter.

### BRIEF DESCRIPTION OF THE DRAWINGS

FIG. 1 is a schematic view of an inductive power system according to the invention.

FIG. 2 is a schematic cross-section of a floor covering according to the invention.

FIG. 3 is a schematic view of the circuitry of the floor covering.

FIG. 4 is a schematic view of a footswitch as a particular appliance.

For clarity, previously identified features retain their reference signs in subsequent drawings.

### DESCRIPTION OF EMBODIMENTS

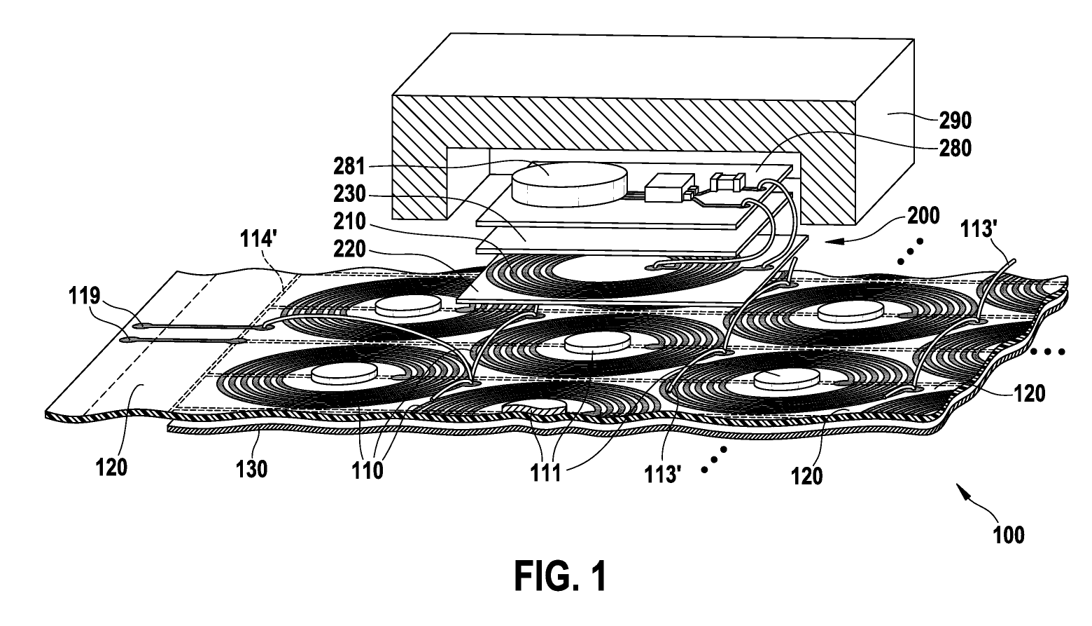

FIG. 1 is a schematic view of an inductive power system according to the invention. An electronic device as a power receiver circuit 200 is movable across a floor covering 100 used, for example, in an office room. The inductive power system generally includes the floor covering 100, a power supply (not shown), which is connected to the floor covering 100 by a connecting part 119 of the floor covering 100, and the power receiver circuit 200. The floor covering 100 comprises a plurality of coils 110 which are operable to supply inductive energy and operates as a base from which a portable appliance accommodating the power receiver circuit 200 with a rechargeable battery 281 is charged.

For example, the floor covering 100 may be a flat, wooden base with the plurality of coils on its rear side onto which the portable appliances, e.g. vacuum cleaners, office tables with additional electronic equipment, lamps, thermostats, foot switches, robots, loudspeakers, furniture with integrated or attached electronic devices, movable machines, thermal shoes, etc. are placed for powering and/or recharging. The floor covering 100 has a size which matches the dimensions of the room in which the appliance is used. Instead of a wooden floor covering 100, a floor covered with linoleum, vinyl or carpet (hand-woven or broadloom) can be used advantageously.

The floor covering 100 includes a plurality of coils 110, i.e. 2 or more, e.g. 5, 10, 50, 100, etc., each coil 110 being operable to receive a charging current from the power supply. Each coil is operable to provide the transmission of inductive energy to (i.e. to induce a voltage on) a receiving inductor 210 in the power receiver circuit 200. The coils 110 and the receiving inductor 210 may be implemented in various forms, for example, as spiral inductors having a particular number of whole or fractional windings.

In the embodiment shown in FIG. 1, the floor covering 100 further includes a plurality of detector circuits 111 (referring to 2 or more detector circuits, e.g. 5, 10, 50, 100, etc.), each detector circuit 111 having a corresponding coil 110 (e.g. detector circuit 111 corresponding to coil 110), and each detector circuit 111 being operable to electromagnetically sense the presence of a power receiver circuit 200. “Electromagnetically sense” herein refers to the detection of an electromagnetic signal (i.e. a signal having an electric, magnetic or combined electromagnetic field) which is communicated between the detector circuit 111 and the power receiver circuit 200. In one embodiment, the electromagnetic signal is a magnetic field which emanates from a magnet located within/on the power receiver circuit 200. In another embodiment, the electromagnetic signal is an electromagnetic RF signal, e.g. an RFID signal transmitted from the power receiver circuit 200 to the detector circuit 111. Other embodiments may also be employed, wherein the detector circuit 111 electromagnetically senses the power receiver circuit 200. For example, the detector circuit 111 may broadcast a signal and the power receiver circuit 200 operates in a conventional transponder manner and transmits a predefined signal when it receives the signal. More generally, any electric, magnetic or electromagnetic field may be used as the detection means for ascertaining the presence of the power receiver circuit 200 proximate to the detector circuit 111. Each detector circuit 111 comprises a switch which, upon electromagnetically sensing the presence of the power receiver circuit 200, is operable to control switching of its corresponding coil 110 to the power supply. A charging current is then permitted to flow to the corresponding coil 110, thereby generating power for transmission to the inductor 210 in the power receiver circuit 200.

In an embodiment further detailed below, the detector circuit 111 is switchably coupled between its corresponding coil 110 and the power supply connected to the floor covering 100 via the connecting part 119 of the floor covering 100. The detector circuit 111 is operable to couple the corresponding coil 100 to the power supply. In another embodiment, the detector circuit 111 is operable to detect a recognized signal (e.g. a recognized RFID signal) and supply it to a receiver (e.g. an RFID receiver), the receiver being operable to control coupling between the corresponding coil 110 and the power supply.

In a further embodiment, the floor covering 100 is operable to concurrently supply inductive energy to a multiplicity (e.g. 2, 5, 10, or more) of power receiver circuits 200. In such an embodiment, a respective multiplicity of detector circuits 111 (or multiple respective groups of detector circuits 111) is operable to electromagnetically and concurrently sense the presence of the multiplicity of power receiver circuits 200, each detector circuit 111 being operable to control switching of its respective coil 110 to the power supply so as to receive a charging current, as described hereinbefore.

The floor covering 100 further includes a power rail or supply line/bus 113′, 114′ as a part of a wiring system integrated in the floor covering 100 for supplying power to each coil 110. The coils 110 are connected to one power rail 113′ and the receiving circuit 111 with the switch is connected to the other power rail 114′. The power supply may be located close to the connecting part 119 of the floor covering 100 and electrically coupled thereto. Each detector circuit 111 is switchably coupled between its corresponding coil 100 and the power supply via the power rail 114′.

The floor covering 100 further includes a magnetic layer 130 (consisting of e.g. a soft-magnetic plate) which is operable to increase the magnetic flux density in the direction of the power receiver circuit 200. The magnetic layer 130 is preferably positioned beneath the coils 110.

The power receiver circuit 200 as shown in FIG. 1 is arranged on top of the center of a coil 110, within a housing 290. The power receiver circuit 200 includes a receiving inductor 210 (e.g. a spiral inductor), a magnetic layer 230, and power electronics 280, including a resonant capacitor, a rectifier and a rechargeable battery 281. The spiral inductor 210 is operable to receive inductive power transmitted by the coil 110. The magnetic layer 230 (consisting of e.g. a soft-magnetic plate) operates to provide the detectable magnetic field to be sensed by the detector circuits 111, and may be arranged as a large/wide area of spiral inductors 210, or alternatively arranged within the center of the spiral inductors 210 to ensure better sensing capability and positioning accuracy. The magnetic layer 230 is further operable to concentrate the magnetic flux density on the receiving inductor 210. The magnetic layer 230 may be a ferrite plate or formed from a material which can be easily laminated onto a printed circuit board 220 or other substrate providing the bulk of the power receiver circuit 200. For example, plastic ferrite compounds or structured highly permeable metal foils (e.g. mumetal, metglas, nanocrystalline iron, etc.) may be used.

Those skilled in the art will appreciate that levels of integration may be employed. For example, one or both of the detection circuits 111 and the power receiver circuit 200 may be implemented as an integrated circuit (e.g. Si, SiGe, GaAs, etc.), with the aforementioned components being monolithically formed into an integrated circuit by means of a photolithographic semiconductor process. Another possibility is to form a hybrid circuit from discrete components.

Passive electric components of the floor covering 100 are preferably realized as printed circuit board-integrated components. Semiconductor ICs may be thinned to reduce vertical height and surface area-reduced so as to minimize risk of breakage.

As mentioned above, the inductive power system of the present invention can be implemented in a wide variety of portable appliances. A particular application of the system is in the field of wireless control modules used in, for example, office rooms in which diversified electronic devices such as computers, phones, lamps, etc. are remotely controlled and supplied with energy.

Wireless operation is preferred; however, portable power supply via batteries is not reliable and presents maintenance problems, as batteries must be periodically checked and, if necessary, replaced. Use of conventional rechargeable batteries requires an exposed power transfer point to recharge the batteries, which may leak. An inductive power system with a floor covering 100 comprising coils 110 makes inductive energy available throughout the office.

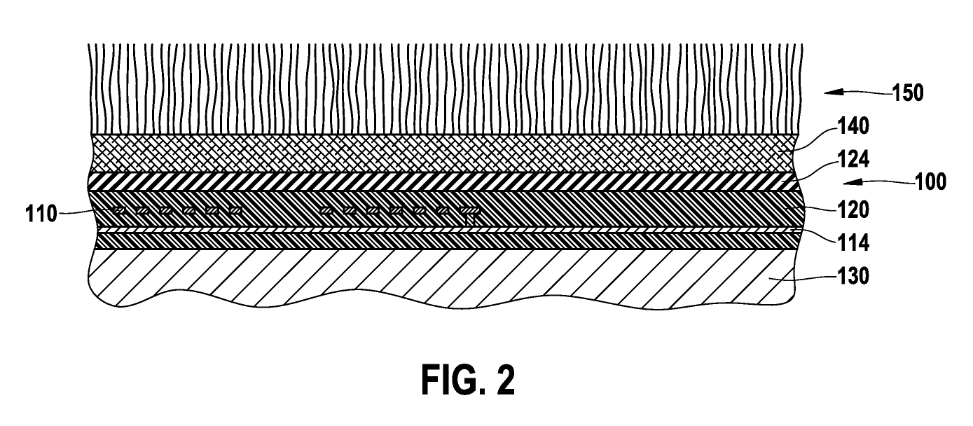

FIG. 2 is a schematic cross-section of an embodiment of a floor covering 100 according to the invention. The floor covering 100 is made as a textile floor cloth comprising an upper protection layer with a carpet-like surface 150. If carpeting is used, the attached floor covering 100 is made of a heavy, thick fabric, usually woven or felted, often wool, but also cotton, hemp, straw, or a synthetic counterpart. Polypropylene is a very common pile yarn. It is typically knotted or glued to a base weave 140. It is made in breadths of typically 4 or 5 meters to be cut, seamed with a seaming iron and seam tape, but formerly it was sewn together and affixed to a floor using nails, tack strips (known in the UK as carpet rods or stair rods, when used on stairs), (grippers) or adhesives, thus distinguishing it from a rug or mat which are loose-laid floor coverings. Carpeting which covers an entire room area is loosely referred to as ‘wall-to-wall,’ but a carpet can be put on any portion thereof while using appropriate transition moldings where the carpet meets other types of floor coverings.

Alternatively, the floor covering 100 may be made of ‘carpet tiles’, which are squares of carpet, typically 0.5 m square, which can be used to cover a floor. They are usually only used in commercial settings and are often not affixed to a floor in order to allow access to the sub-floor (for example, in an office environment) or to allow rearrangement in order to spread wear. The wiring system 113, 114 of these carpet tiles is realized by using flat connectors between each square.

A flexible substrate 120 includes the wiring system 114 and the plurality of coils 110 in different, laminated layers. The wires 114 of the wiring system and the coils 110 are integrated in the flexible substrate 120. This flexible substrate 120 is attached to the protection layer with the carpet-like surface 150 and the weave 140. In the embodiment shown in FIG. 2, the flexible substrate 120 is glued to the weave 140 by means of an adhesive layer 124. Alternatively, the weave itself may be the flexible substrate comprising the wiring system 114 and the coils 110.

The flexible substrate 120 is used in the construction of the coils 110, e.g. polyimide (“Flexfoil”). Electronic components may be located on top or below the coils 110, or between them, the construction of the floor covering 100 being suitable for heavy loads on its top while remaining operable, because the copper wires 114, the foils with spiral windings 110 and the magnetic foils 130 are all flexible. The resulting floor covering 100 can be handled right away as any other floor covering, and can be specifically stored on a roll.

Additionally, the floor covering 100 comprises the magnetic material 130, which is capable of improving the magnetic coupling between the coils 110 and the power receiver circuit 200. The magnetic material may be a magnetic foil 130 made of a ferrite polymer compound.

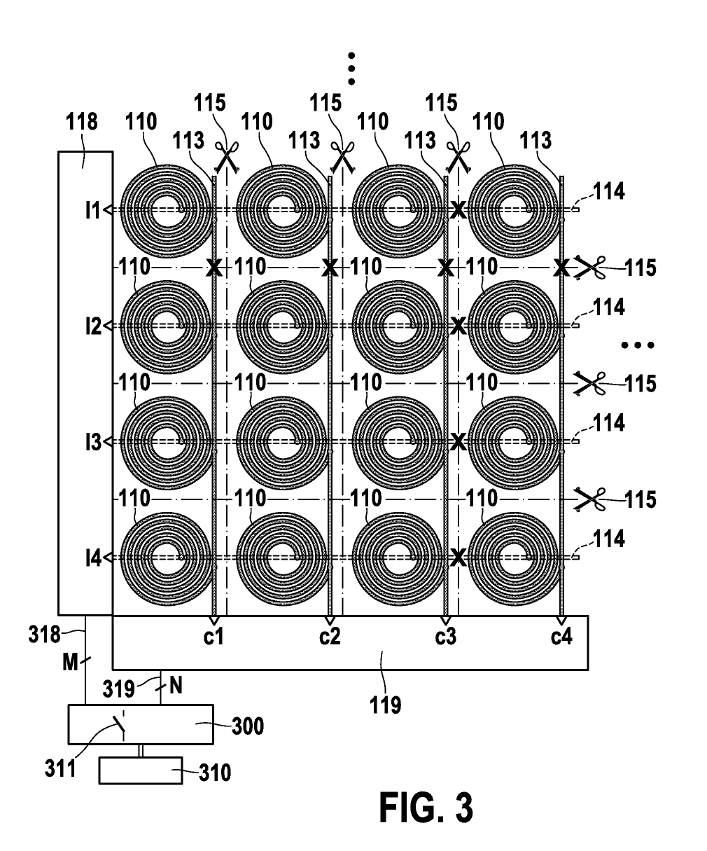

FIG. 3 is a schematic view of the circuitry of the floor covering 100 and other parts of the inductive power system. The floor covering 100 of the embodiment shown in FIG. 3 comprises sixteen coils 110 arranged in a matrix configuration. The wiring system connecting the coils 110 comprises four row wires 114 and four column wires 115. Each wire 114, 115 of the wiring system is connected to a connecting part 118 for the rows 11, 12, 13, 14 and a connecting part 119 for the columns c1, c2, c3, c4, respectively.

Optical indicators 115 (on the rear side) indicate where to cut the material best without cutting wires unnecessarily. Cut wires may deactivate complete rows or columns of coils 110. The indicators 115 can also indicate predetermined points of fracture, which are marked X to allow disconnection of parts of coils 110 which have to be cut when tailoring the floor covering 100.

The floor covering 100 is connected to a control circuit 300 via a parallel bus 318 having a number M of wires corresponding to the number of rows and via a parallel bus 319 having a number N of wires corresponding to the number of columns. The control circuit 300 comprises at least (M+N) switches 311 to connect each coil 110 to the power supply 310. The control circuit 300 required to operate the coils 110 may be integrated in the base board.

The embodiment shown in FIG. 3 uses a wireless network (not shown) such as ZigBee or WLAN for the specific coils 110 to which the charging current has to be switched by the control circuit 300. The control circuit 300 switches a current temporarily to a specific coil 110, with a modulated identification of this coil 110. The power receiver circuit 200, which needs to be charged or supplied, receives this code if it is above the corresponding coil 100. Along with other data, the power receiver circuit 200 sends the identification to the control circuit 300 via the wireless network. The control circuit 300 then just has to switch the charging current to the corresponding coil 110. Additionally, the control circuit 300 is operable as a transmitting circuit transmitting data to the power receiver circuit 200. This data transmission may be one-directional or bi-directional. Alternatively, the floor covering 100 may comprise detector circuits 111 similarly as in the embodiment shown in FIG. 1.

The coils may also have different shapes. For example, they may comprise wires from one to the other end of the floor covering, resulting in an elongated coil shape. Several of these elongated coils may be arranged in different, e.g. perpendicular directions so as to form an array. The wires of a plurality of coils can be connected by using a single terminal on at least one side of the floor covering.

### Examples of Applications

As mentioned above, the floor covering and the inductive power system of the present invention can be implemented in a wide variety of portable appliances. A particular application of the system is in the field of wireless control modules. For example, the wireless control module may be implemented as a footswitch for controlling movement of a medical instrument or device, such as a patient's chair in a dental office, or to control aspects of an X-ray diagnostic system, such as a patient's table movement, gantry movement, release of X-rays, and the like (such instruments being referred to collectively as “medical devices”). Another application is in the industrial field, in which machines may be controlled by a wireless remote control unit. Further examples of applications are (automatic) vacuum cleaners, office tables with additional electronic equipment, lamps, thermostats, foot switches, robots, loudspeakers, furniture with integrated or attached electronic devices, movable machines, thermal shoes, etc. for powering and/or recharging.

Conventional foot switches, which provide control by wired means, are disadvantageous, because they require a significant effort to clean and disinfect. Wireless operation is preferred; however, portable power supply via batteries is not reliable and presents maintenance problems, because batteries must be periodically checked and, if necessary, replaced. Use of conventional rechargeable battery requires an exposed power transfer point to recharge the batteries, which may leak. An inductive power system in which the control unit is sealed provides the best solution.

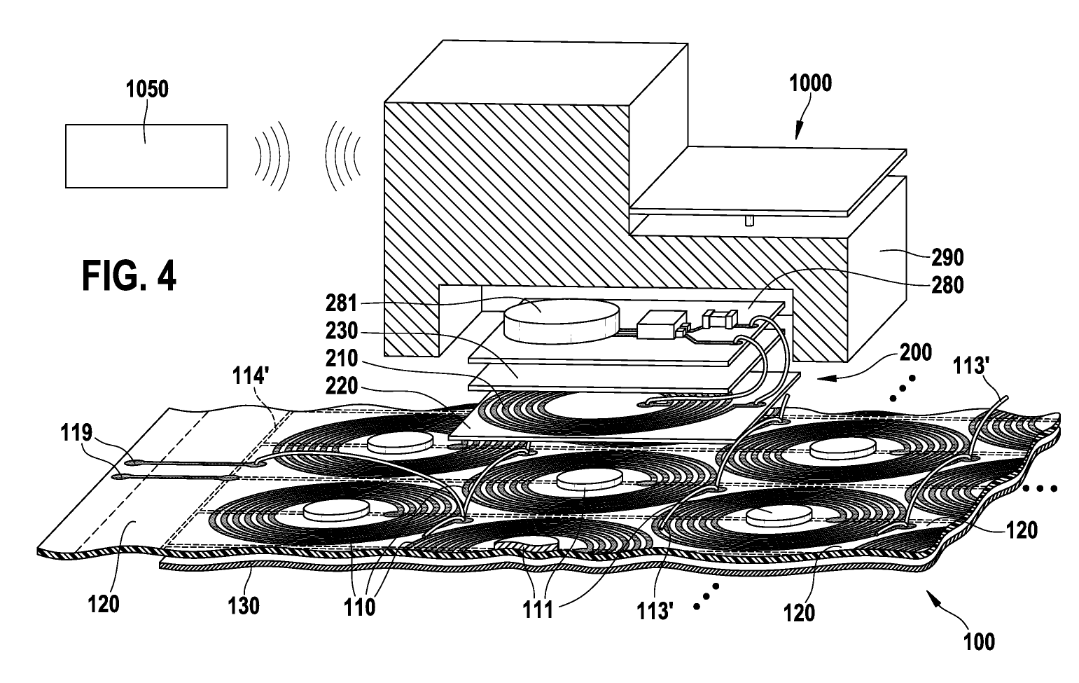

FIG. 4 shows a foot switch controller 1000 on a floor covering 100 incorporating an inductive power system according to the invention. The foot switch controller 1000 is operable for wireless communication with a wireless receiver 1050 and includes a power receiver circuit 200 for receiving power from coils 110 of the floor covering 100. In a particular embodiment, the foot switch controller 1000 is operable to wirelessly control an X-ray apparatus 1050 regarding, for example, the movement of a patient bed, gantry or release of X-ray radiation in a CT system.

The floor covering 100 may be constructed as a loose mat partly covering the room or fixed to the floor and cover it completely (collectively “transmitter area”) on which the foot switch controller 1000 is placed for operation and/or periodical charging. If the covering is constructed as a loose flexible mat, a flexible substrate is used in the construction of the coils 110, e.g. polyimide (“Flexfoil”). The electronic components may also be located on top or below the coils 110, or between them, the construction of the mat—the protection layer and the coils—being suitable for heavy loads on top while remaining operable. The mat may be covered with a thin, anti-slip rubber layer on the back and a sealed protection layer on its top surface. The mat may also be hermetically sealed so as to allow easy cleaning.

To achieve a uniform height, which allows a good pressure distribution, an additional layer may be added to the flexible mat. This layer is made of a material which is not compressed when stepping on it, and as it must accommodate electric components, this layer has a height which is approximately equal to that of such components. In this manner, the components are buried in and protected by the holes of the layer. The holes may be additionally filled with epoxy to provide further protection.

The mat may further include an inclined area without coils at the edges so as to avoid a step from the floor to the charging area. The edges may be made of a flexible material (e.g. rubber) to achieve a sealing function with respect to contaminating fluids, such that the bottom surface of the mat stays clean.

When the floor covering 100 is fixed to the floor, the transmitter area may be equipped with borders so as to facilitate retention of the foot switch controller 1000 within this area. Furthermore, the gap between the plane of the floor and the coils 110 is filled with a material, such as an epoxy plastic, which is fluid during installation and then fills all gaps and holes with minimal air gaps.

The housing 290 of the foot switch controller 1000 is preferably constructed from non-conducting material in order to avoid induced eddy currents that might cause unintended losses. In order to reduce loss of the induced energy, the receiving coil (e.g. a spiral inductor) 210 is arranged in a hole which has a slightly larger diameter than the spiral coil 110. In an alternative embodiment, the housing 290 has a recess which contains a matrix of spiral coils, each of which faces the exterior of the housing. The foot switch controller 1000 may be equipped with an indicator lamp indicating that inductive power is being received and that the battery is charged (when so equipped). In one embodiment, the foot switch controller 1000 contains no local energy storage and is only powered by the received inductive energy. Operation without a rechargeable power source simplifies the controller design and reduces cost and maintenance needed for checking and, if necessary, replacing a rechargeable battery.

Electromagnetic sensing may be realized by means of an RFID tag located within the portable foot switch 1000 (or the power receiver circuit 200 therein), and an RFID receiver 111 within the floor covering 100. For example, the RFID tag and corresponding RFID receiver 111 may be tuned to a unique signal, thereby preventing unauthorized use of the foot switch controller 1000 in other areas, or interference from another foot switch controller.

It should be noted that use of the verb “comprise” and its conjugations does not exclude other features, and the indefinite article “a” or “an” does not exclude a plurality, except when indicated. It is to be further noted that elements described in association with different embodiments may be combined. It is also noted that reference signs in the claims shall not be construed as limiting the scope of the claims.

The foregoing description has been presented for purposes of illustration and elucidation. It is not intended to be exhaustive or limit the invention to the precise form disclosed, and obviously many modifications and variations are possible within the scope of the invention. The described embodiments were chosen in order to explain the principles of the invention and its practical application so as to thereby enable others skilled in the art to best utilize the invention in various embodiments and with various modifications as are suited to the particular use contemplated. It is intended that the scope of the invention be defined solely by the appended claims.

1. A floor covering (100) comprising:
a plurality of coils (110), each coil (110) being operable to supply inductive energy to a power receiver circuit (200);
wherein the plurality of coils comprises a transmitter area occupying the largest area of the floor covering (100); and
a charging current through the coils is operable to generate said inductive energy.

2. The floor covering (100) of claim 1, further comprising an upper protection layer (140, 150) and a wiring system (113 114, 113′, 114′) which is operable to supply said charging current from a power supply (310) to said plurality of coils (110);
wherein wires (113, 114, 113′, 114′) of said wiring system (113, 114, 113′, 114′) and/or said plurality of coils (110) are integrated in a flexible substrate (120); and
said flexible substrate (120) is attached to said protection layer (140, 150).

3. The floor covering (100) of claim 1, further comprising an upper protection layer (140, 150) and a wiring system (113 114, 113′, 114′) which is operable to supply said charging current from a power supply (310) to said plurality of coils (110);
wherein wires of said wiring system and/or said coils are woven and/or embroidered and/or sewn into the upper protection layer.

4. The floor covering (100) of claim 1, wherein at least two coils (110) of the plurality of coils (110) are positioned adjacent to each other.

5. The floor covering (100) of claim 1, further comprising a plurality of switches (111), each switch (111) corresponding to at least one coil (110) of said plurality of coils (110), wherein each switch (111) is operable to switch said charging current to said at least one connected coil (110).

6. The floor covering (100) of claim 5, wherein said wiring system (113′, 114′) further comprises at least one power rail (114′) connected to each switch (111) and to said power supply.

7. The floor covering (100) of claim 1, further comprising a magnetic material (130) which is capable of improving the magnetic coupling between said coils (110) and said power receiver circuit (200).

8. The floor covering (100) of claim 1, further comprising a visual indicator (115) indicating areas for cutting the floor covering (100) or a predetermined point of fracture, disconnecting parts of said coils (110).

9. The floor covering (100) of claim 1, further comprising a respective plurality of detector circuits (111), each detector circuit (111) corresponding to one of the plurality of coils (100) and each detector circuit (111) being operable to electromagnetically sense a power receiver circuit (200);
wherein, upon electromagnetically sensing a power receiver circuit (200), each detector circuit (111) enables switching of its corresponding coil (110) to a power supply, thereby supplying a charging current to said corresponding coil (110), said charging current being operable to generate inductive energy for transmission to said power receiver circuit (200).

10. An inductive power system comprising:
a floor covering (100) and a power receiver circuit (200) which is movable across the floor covering (100) and is operable to receive inductive energy;
wherein the floor covering (100) comprises:
a plurality of coils (110), each coil (110) being operable to supply said inductive energy to said power receiver circuit (200);
the plurality of coils comprises a transmitter area occupying the largest area of the floor covering (100); and
said charging current is operable to generate said inductive energy.

11. The inductive power system of claim 10, comprising a remote control device (1000) with a transmitter which is operable to remotely control an electronic device (1050) wirelessly, wherein the remote control device (1000) comprises said power receiver circuit (200).

12. The inductive power system of claim 10, further comprising a transmitting circuit (300) connected to said plurality of coils (110), said circuit being operable to transmit data to the power receiver circuit (200).
